(19) United States
(12) Patent Application Publication
(10) Pub. No.: US 2011/0302035 A1
(43) Pub. Date: Dec. 8, 2011

(54) ADVERTISING SYSTEM AND METHOD USING A POTENTIAL CUSTOMER'S VEHICLE INFORMATION

(76) Inventor: Anthony Stasio, New Rochelle, NY (US)

(21) Appl. No.: 12/792,063

(22) Filed: Jun. 2, 2010

(51) Int. Cl. G06Q 30/00

(52) U.S. Cl. 705/14.61; 705/14.49; 705/14.66

(57) ABSTRACT

A system for targeted advertising is disclosed, which communicates advertisement messages to a potential customer based upon information regarding a vehicle owned and/or operated by the potential customer. A vehicle information obtainer obtains the potential customer's vehicle information, an advertising message generator generates an advertising message determined to be of interest to the potential customer, based on a projection of the potential customer's general purchasing mindset, and an advertising message communicator communicates the advertising message to the potential customer. The vehicle information can be obtained, and the advertising message generated and communicated, by a person, and/or through an automated system. The advertising message can be based on such vehicle information as make and model, luxury level, accessories, and model year. The advertising message can offer a product and/or service, or discounts or information pertaining thereto, and can also be informed by information other than the potential customer's vehicle.

### FIELD

The invention generally relates to advertising systems and methods, and more specifically to customer-profile-based advertising systems and methods.

### BACKGROUND

Targeted advertising is well known. Providers of products and services generally wish to have advertisements offered to their most likely buyers, but reaching their full potential customer base can be a challenge. One advertising technique is to advertise in certain geographic areas where a product or service is determined to be desirable, or to target a certain demographic of the population that is assumed to have an interest in the type of product or service being offered. Another form of advertising is contextual advertising, which places advertisements appropriately where other related information is offered. Alternatively, advertisements can be targeted towards certain potential customers based on their behavior or purchasing history.

Taking into account a potential customer's past purchasing history is a known method of targeted advertising. Some advertising systems can generate and communicate a wide variety of advertising messages to a potential customer, based upon the potential customer's past purchasing history. However, given the extensive research and decision-making required for delivering a wide variety of targeted advertising messages to appropriate recipients, a considerable amount of time is generally required, from the moment of receiving a potential customer's relevant information, up until effective delivery of such a variety of advertising messages.

### SUMMARY

A system for targeted advertising is claimed, which communicates advertising messages to a potential customer based upon information regarding a vehicle owned and/or operated by the potential customer. The vehicle information is used as the basis for generating at least one appropriate advertising message. While the potential customer's vehicle is only one element of the potential customer's purchasing history, it is used to project a general purchasing mindset of the potential customer. Appropriate advertisements can be researched and associated with the appropriate vehicle information in advance, and can be available for quick look-up. Due to the straightforward manner of this approach, a wide variety of targeted advertising messages can be delivered to a potential customer essentially in real time.

In one embodiment, a vehicle information obtainer obtains the potential customer's vehicle information, an advertising message generator generates an advertising message determined to be of interest to the potential customer, based on the projection of a general purchasing mindset of the potential customer, and an advertising message communicator communicates the advertising message to the potential customer.

The vehicle information can be obtained, and the advertising message generated and communicated, by a person, and/or through an automated system. The advertising message can be based on such vehicle information as make and model, luxury level, accessories, and model year. The advertising message can offer a product and/or service, or a discount, free trial, or information pertaining thereto. The advertising message can also be informed by information other than the potential customer's vehicle.

A system of providing an advertising message based on information regarding a potential customer's vehicle is claimed, the system comprising: a vehicle information obtainer, the vehicle information obtainer being capable of obtaining vehicle information regarding a vehicle at least one of owned and operated by a potential customer; an advertising message generator, the advertising message generator being capable of generating at least one targeted advertising message determined to be of interest to the potential customer, the advertising message generator using the vehicle information as a basis for a projection of a general purchasing mindset of the potential customer; and an advertising message communicator, the advertising message communicator being capable of communicating the at least one targeted advertising message to the potential customer.

In some embodiments, the vehicle information obtainer is: a person capable of determining the vehicle information; a machine vision system capable of determining the vehicle information; a software program capable of soliciting the vehicle information directly from the potential customer; a software program capable of obtaining the vehicle information from a source other than the potential customer; a speech-recognition system capable of obtaining the vehicle information via speech recognition; an email-based system capable of obtaining the vehicle information via an email; and/or a telephony-based system capable of obtaining the vehicle information via a telephone call to the potential customer.

In some of these embodiments, the software program capable of obtaining the vehicle information directly from the potential customer is a web-based software program. In some of these embodiments, the software program capable of obtaining the vehicle information from a source other than the potential customer is a web-based software program.

In some embodiments, the advertising message generator is: a manual look-up table capable of relating the vehicle information to the at least one targeted advertising message; or an automated look-up table capable of relating the vehicle information to the at least one targeted advertising message. In some embodiments, the advertising message generator is: a lookup of a pre-assembled advertising message; or a real-time assembly of an advertising message.

In some embodiments the advertising message communicator is: a person capable of communicating the advertising message; a printer capable of printing the advertising message; a speech-synthesis system capable of providing a spoken advertising message; an audio system capable of presenting an audio advertising message; a video system capable of presenting a video advertising message; an SMS text message generator capable of generating and sending a text message advertising message; an email generator capable of generating and sending an email advertising message; and/or a telephony-based system capable of delivering an advertising message via a telephone call.

In some embodiments, the information regarding a potential customer's vehicle includes: make information, and/or model information. In some of these embodiments, model information includes sub-model information indicating luxury level.

In some embodiments, the information regarding a potential customer's vehicle includes accessories information. In some embodiments, the information regarding a potential customer's vehicle includes model year.

In some embodiments, the advertising message is: an offer of a product; an offer of a service; an offer of a discount on a product; an offer of a discount on a service; an offer of a free trial on a product; an offer of a free trial on a service; information about a launch of a product; information about a launch of a service; information relating to sale of a product; information relating to sale of a service; information relating to a product; and/or information relating to a service.

In some embodiments, the advertising message is further informed by non-vehicle-related information pertaining to the potential customer. In some of these embodiments, the non-vehicle information is the gender of the potential customer. In some other of these embodiments, the non-vehicle-related information is the age of the potential customer. In still other of these embodiments, the non-vehicle information is the location of residence of the potential customer. In still other of these embodiments, the non-vehicle information is the location of place of business of the potential customer.

In some embodiments, the advertising message is further informed by non-potential-customer-related information. In some of these embodiments, the non-potential-customer-related is the location where the advertising message is given. In still other of these embodiments, the non-potential-customer-related information is the time of day.

### BRIEF DESCRIPTION OF THE DRAWINGS

The invention will be more fully understood by reference to the detailed description, in conjunction with the following figures, wherein:

FIG. 1 is a block diagram illustrating an embodiment of the advertising system;

FIG. 2A is an illustration of an embodiment of the advertising system, showing a parking garage employee obtaining vehicle information from a potential customer at a parking garage;

FIG. 2B is an illustration of the embodiment of FIG. 2A, showing the parking garage employee providing coupons to the potential customer;

FIG. 3A is an illustration of an embodiment of the advertising system, showing a machine-vision system obtaining a customer's vehicle information;

FIG. 3B is an illustration of the embodiment of FIG. 3A, showing a display system presenting an audio-visual advertising message to the potential customer;

FIG. 4A is an illustration of an embodiment of the advertising system, showing a potential customer responding to an email;

FIG. 4B is an illustration of the embodiment of FIG. 4A, showing the potential customer receiving an advertising message via an SMS text message;

FIG. 5 is an illustration of an embodiment of the advertising system, showing a potential customer providing vehicle information, and receiving an advertising message, via a website;

FIG. 6A is an illustration of an embodiment of the advertising system, showing a potential customer inputting vehicle information into a machine via a touch screen;

FIG. 6B is an illustration of the embodiment of FIG. 6A, showing the machine displaying an advertising message to the potential customer, and dispensing a coupon; and

FIG. 7 is a flow chart detailing the steps involved in an implementation of an embodiment of the advertising system.

### DETAILED DESCRIPTION

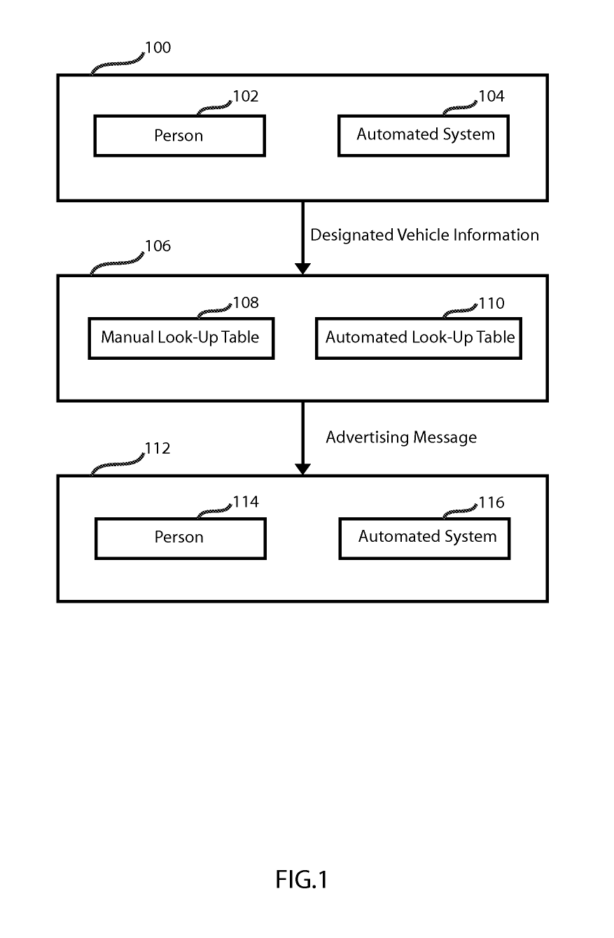

FIG. 1 is a block diagram illustrating an embodiment of the advertising system. A vehicle information obtainer 100 first obtains vehicle information regarding a vehicle owned and/or operated by a potential customer, who is to be the target of an advertising message. The vehicle information obtainer 100 can be a person 102 capable of determining such vehicle information, or an automated system 104 such as a software program, speech-recognition system, or email- or telephony-based system capable of obtaining such vehicle information. Other systems capable of obtaining vehicle information for the purpose of the advertising system will be readily appreciated by one of ordinary skill in the art. The vehicle information obtained by the vehicle information obtainer 100 can include such information as make and model of the potential customer's vehicle, sub-model information indicating luxury level, accessories information, and/or model year, for example.

After the vehicle information obtainer 100 obtains the designated vehicle information, an advertising message generator 106 capable of generating an advertising message or messages determined to be of interest to the consumer, generates such an advertising message or messages. The advertising message generator 106 can be a manual look-up table 108 capable of relating the vehicle information to the advertising message, which can be used by a human user for example; or, an automated look-up table 110 capable of relating the vehicle information to the advertising message, operated via a software program for example. The advertising message generator 106 can be a lookup of a pre-assembled advertising message, and/or a real-time assembly of an advertising message. The advertising message can be an offer of a product or service, or a discount (potentially including a rewards program) or free trial of a product or service, or other information relating thereto, for example. Other examples of advertising message content include information relating to a product line extension, or a cross-sell and/or up-sell.

An advertising message generator can use research information to generate an appropriate advertising message to a given potential customer, based upon that potential customer's vehicle information. In some cases, the research information may already exist from previous research done for other purposes. For example, a marketing company may have research information pertaining to what certain vehicles a potential customer may be interested in, given their known purchasing history with regard to various other products and services. Conversely, such previously acquired research information could be used for the opposite objective, that is, to determine what kinds of products and services a potential customer may be interested in, given their known vehicle information. Another marketing strategy can be to categorize potential customers into certain economic classes or fields, given their vehicle information, and then use the category or field to determine what class of products and/or services the potential customer may be interested.

Finally, an advertising message communicator 112 capable of communicating the advertising message or messages, communicates the advertising message or messages to the potential customer. The advertising message or messages are informed by the potential customer's vehicle information, and determined to be of interest to the potential customer based on the vehicle information. The advertising message communicator 112 can be a person 114 capable of communicating the advertising message, or an automated system 116 such as a printer capable of printing the advertising message, an audio and/or video system capable of presenting an audio and/or video advertising message, or some other automated system capable of generating an advertising message, via SMS text message, email, or telephone call, for example.

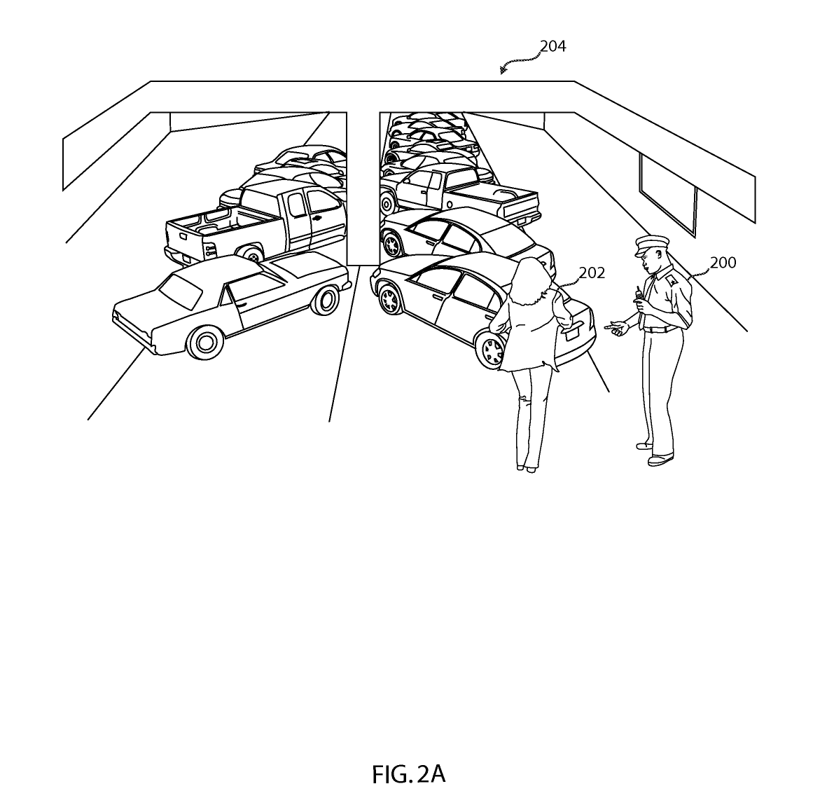

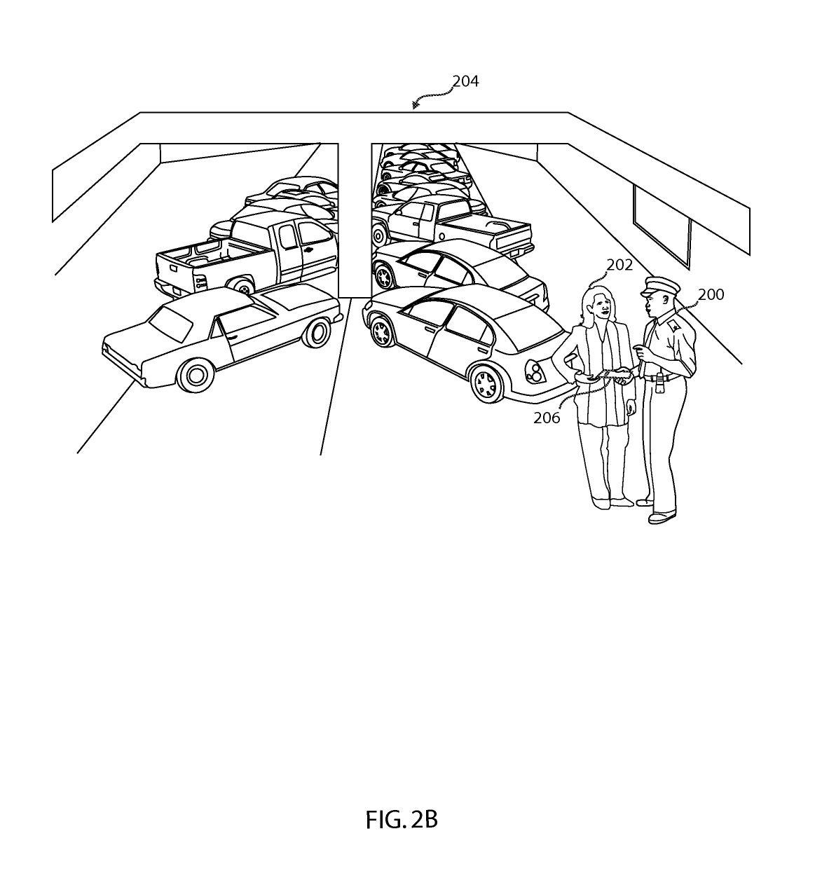

FIG. 2A is an illustration of an embodiment of the advertising system, showing a parking garage employee 200 obtaining vehicle information from a potential customer 202 at a parking garage 204. In this embodiment of the advertising system, the vehicle information obtainer is a person 200 capable of determining the vehicle information by observing the potential customer's vehicle, or communicating with the potential customer 202, for example. In the figure, the parking garage employee is obtaining information from the potential customer through dialogue. Alternatively, the parking garage employee can obtain the vehicle information through direct observation.

FIG. 2B is an illustration of the embodiment of FIG. 2A, showing the parking garage employee 200 providing coupons 206 to the potential customer 204. In this embodiment, the advertising message communicator is also a person 200 capable of delivering a coupon or coupons 206 to the potential customer 202. The advertising message generator in this case can be a lookup of a pre-assembled advertising message, and/or a real-time assembly of an advertising message. For example, the parking garage employee 200 can execute an automated lookup of the correct coupons and a printout, to deliver to the potential customer 204, or the employee 200 can be capable of manually look up the correct coupons, which the employee 200 then can manually select and deliver to the potential customer 204. In instances of automated look up, the automated look up and printing of the coupon can be executed on a machine that is accessible to the parking garage employee, such as one located in the parking garage employee's station, for example.

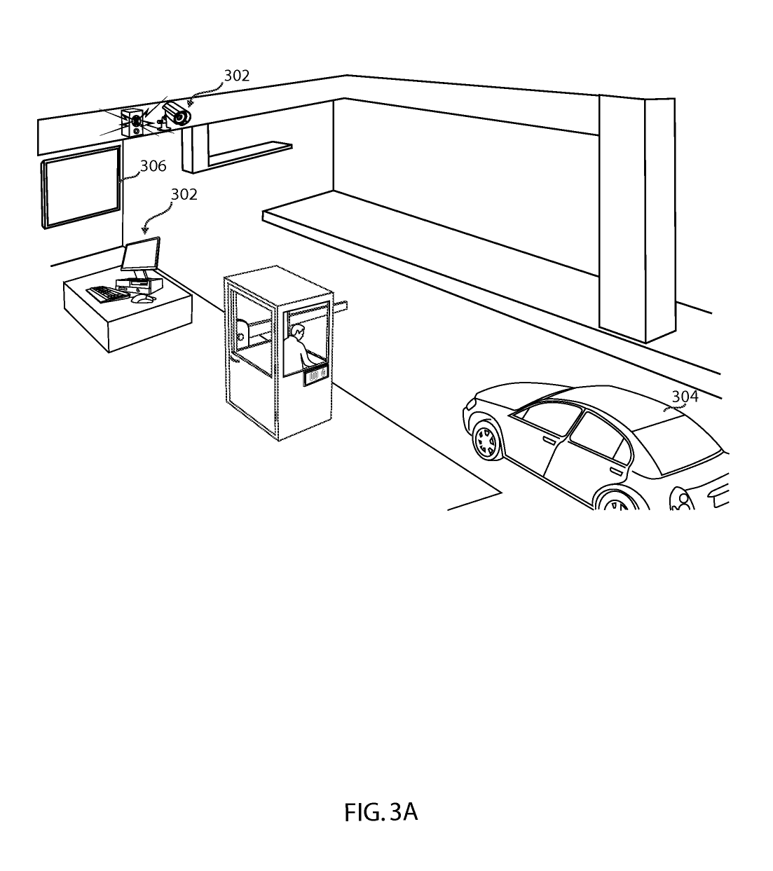

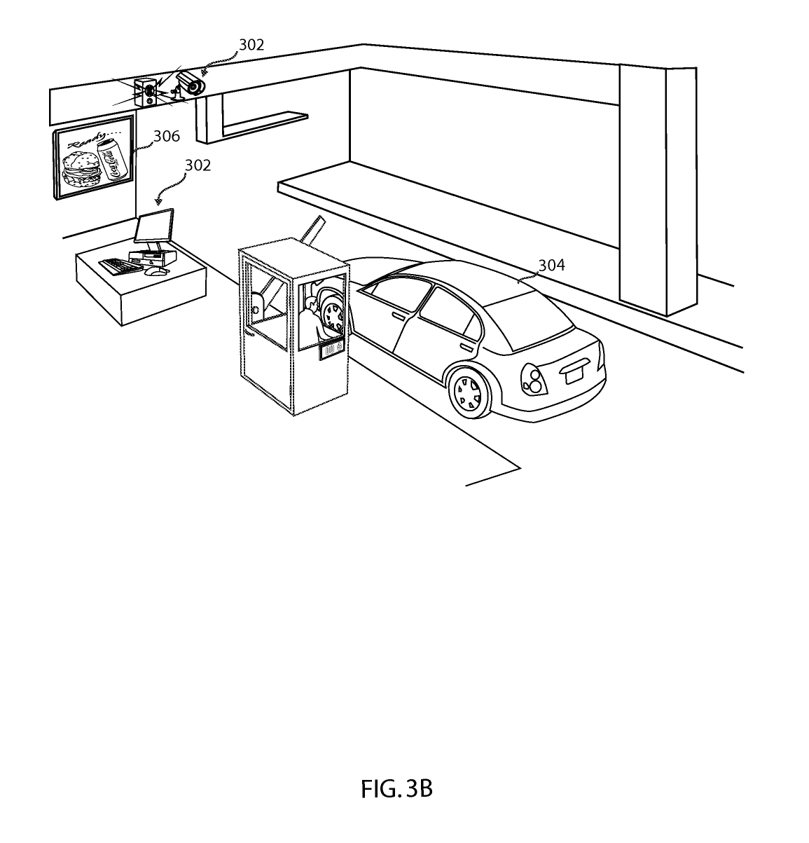

FIG. 3A is an illustration of an embodiment of the advertising system produced at the entry to a parking garage 300, showing a machine-vision system 302 obtaining a potential customer's vehicle information. A machine-vision system 302 can capture an image of a vehicle 304 or a portion thereof, and obtain vehicle information from the image. This vehicle information can then serve as the basis of an advertising message.

FIG. 3B is an illustration of the embodiment of FIG. 3A, showing a display system 306 presenting an audio-visual advertising message to the potential customer. In this case, the advertising message communicator is an audio and visual display system 306. The advertising message generator in this case can be an automated look-up table capable of relating the vehicle information to the targeted advertising message or messages. The advertising message generator can be a lookup of a pre-assembled advertising message, which is output via the audio-visual system as an advertising message.

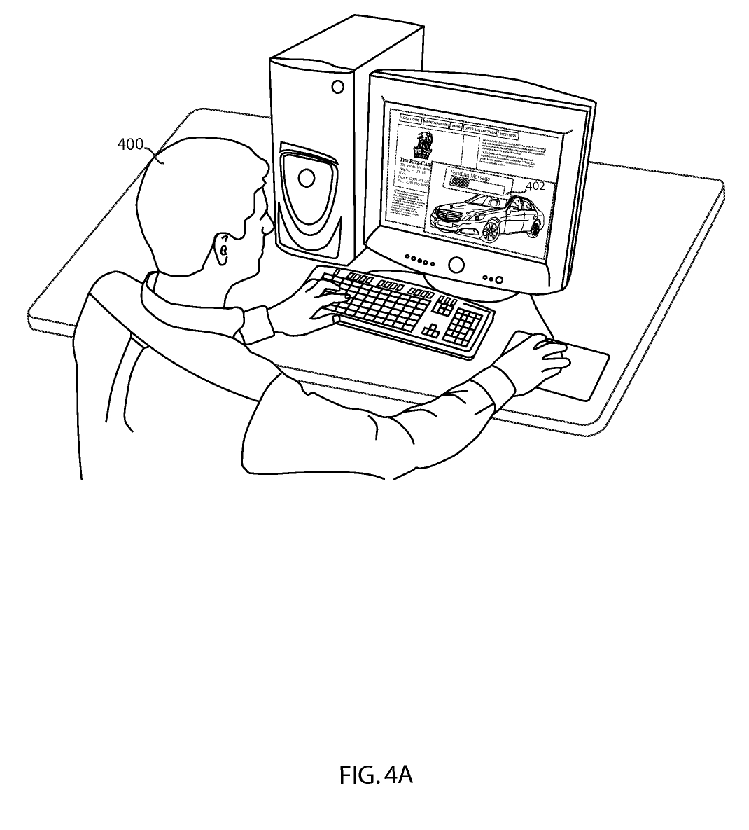

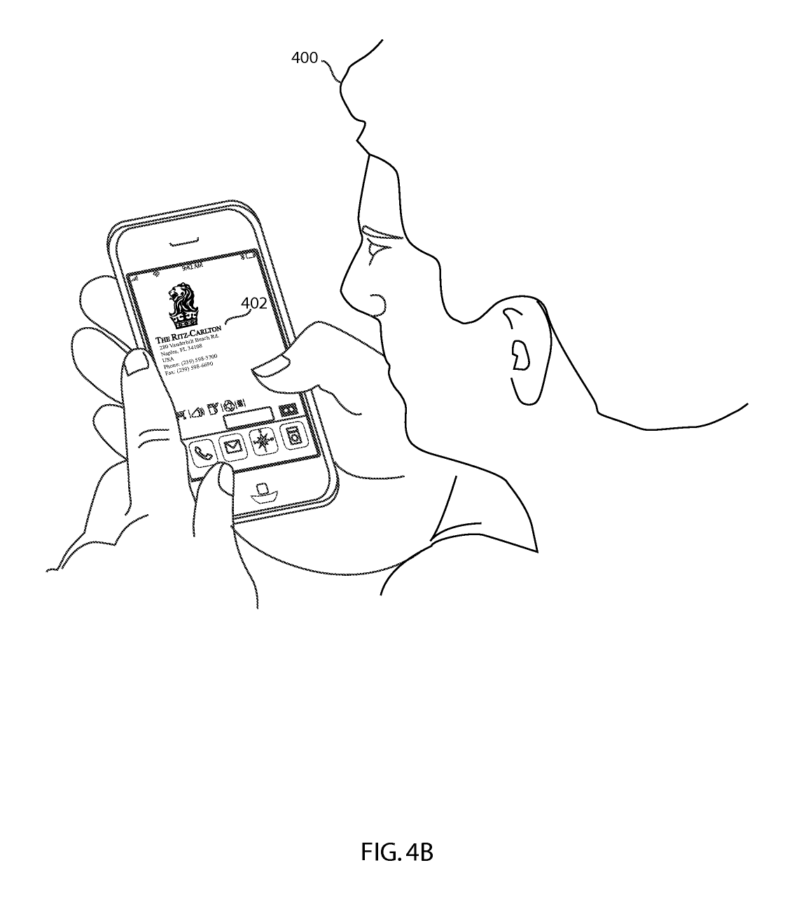

FIG. 4A is an illustration of an embodiment of the advertising system, showing a potential customer 400 responding to an email message 402. In this embodiment, the vehicle information obtainer is an email-based system. For example, an automated email message 402 can be sent to a potential customer 400 requesting the customer's vehicle information. The potential customer 400 can respond to this email request, with an email message 402 including their vehicle information.

FIG. 4B is an illustration of the embodiment of FIG. 4A, showing the potential customer 400 receiving an advertising message via an SMS text message 402. In this embodiment, the advertising communicator is an SMS text message generator which generates and sends a text message advertising message 402. The advertising message generator in this case can be an automated look-up table capable of relating the vehicle information to the targeted advertising message or messages. The advertising message generator can also be a manual look-up capable of relating the vehicle information to the targeted advertising message or messages. The advertising message generator can be a lookup of a pre-assembled advertising message, which is output via the SMS text sending system as an advertising message. Alternatively, or in conjunction with the lookup, the advertising message generator can be a real-time assembly of an advertising message.

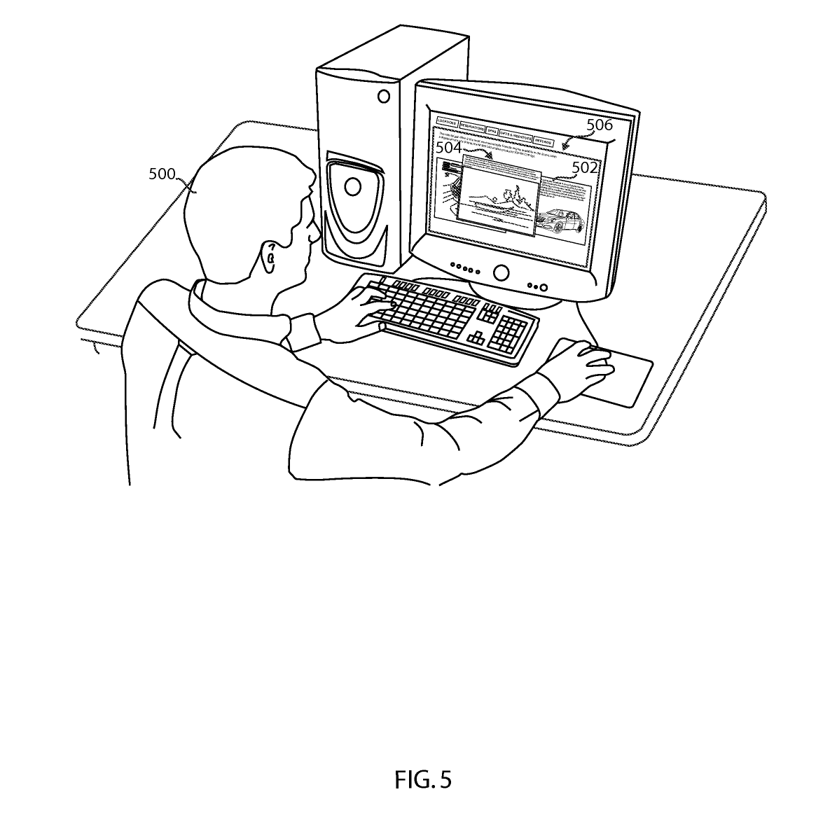

FIG. 5 is an illustration of an embodiment of the advertising system, showing a potential customer 500 providing vehicle information 502 and receiving an advertising message 504 via a website 506. The vehicle information obtainer in this embodiment is a web-based software program capable of obtaining the vehicle information directly from the potential customer 500. The advertising message communicator in this embodiment can be an email generator capable of generating and sending an email advertising message 504.

The advertising message generator in this case can be an automated look-up table capable of relating the vehicle information to the targeted advertising message or messages. The advertising message generator can also be a manual look-up capable of relating the vehicle information to the targeted advertising message or messages. The advertising message generator can be a lookup of a pre-assembled advertising message, which is output via the SMS text sending system as an advertising message. Alternatively, or in conjunction with the lookup, the advertising message generator can be a real-time assembly of an advertising message.

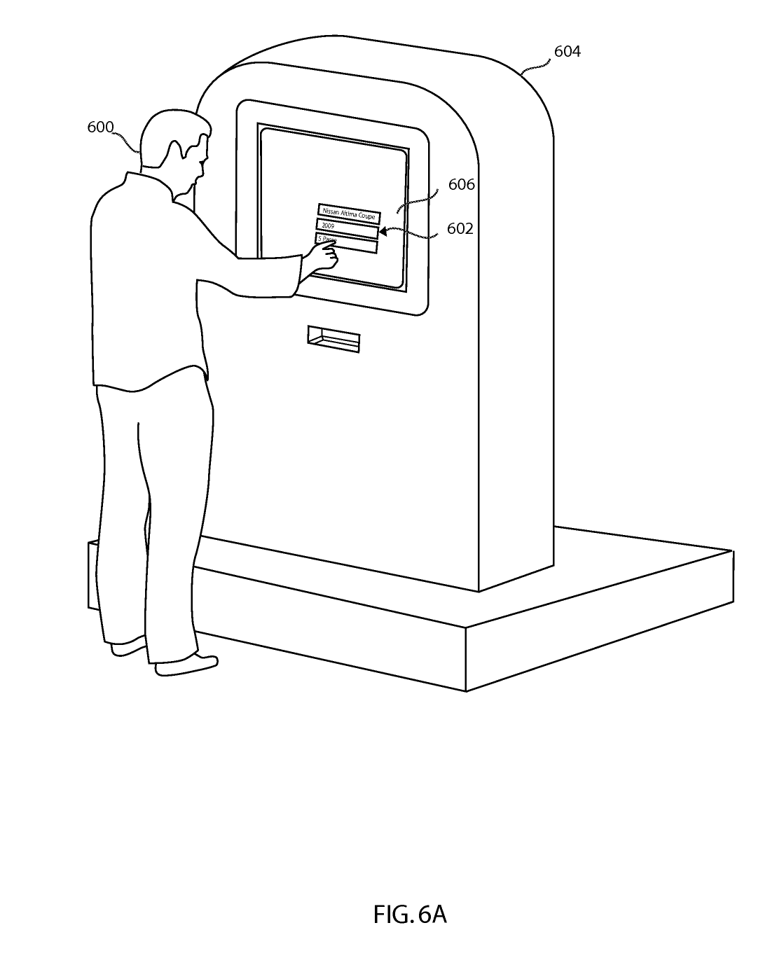

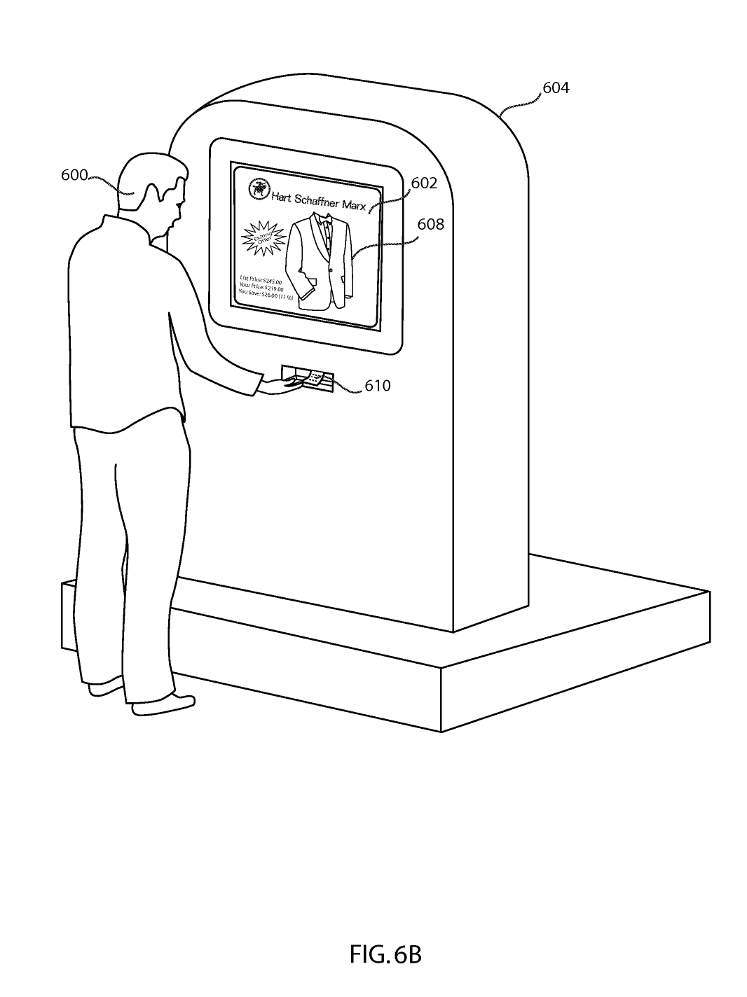

FIG. 6A is an illustration of an embodiment of the advertising system, showing a potential customer 600 inputting vehicle information 602 into a machine 604 via a touch screen 606. In this embodiment, a machine 604 with a touch screen 606 can receive input from a potential customer 600 via the touch-screen's graphical user interface. The vehicle information obtainer can be a software program capable of obtaining the vehicle information from the potential customer.

FIG. 6B is an illustration of the embodiment of FIG. 6A, showing the machine 600 displaying an advertising message 608 to the potential customer 600, and dispensing a coupon 610. In this embodiment, the advertising message communicator includes a printer capable of printing a coupon 610, as well as a textual and graphical interface capable of providing an advertising message 608 on a screen. The advertising message communicator can potentially further include an audio- and/or video- based system capable of presenting an audio and/or video advertising message. The advertising message communicator in this case can also potentially include a speech-synthesis system capable of providing a spoken advertising message. Other methods of communicating advertising messages will be readily understandable to one of average skill in the art.

The vehicle information generator of this embodiment can be an automated look-up table capable of relating the vehicle information to the targeted advertising message or messages. The advertising message generator can also be a manual look-up capable of relating the vehicle information to the targeted advertising message or messages. The advertising message generator can be a lookup of a pre-assembled advertising message, which is output via the SMS text sending system as an advertising message. Alternatively, or in conjunction with the lookup, the advertising message generator can be a real-time assembly of an advertising message.

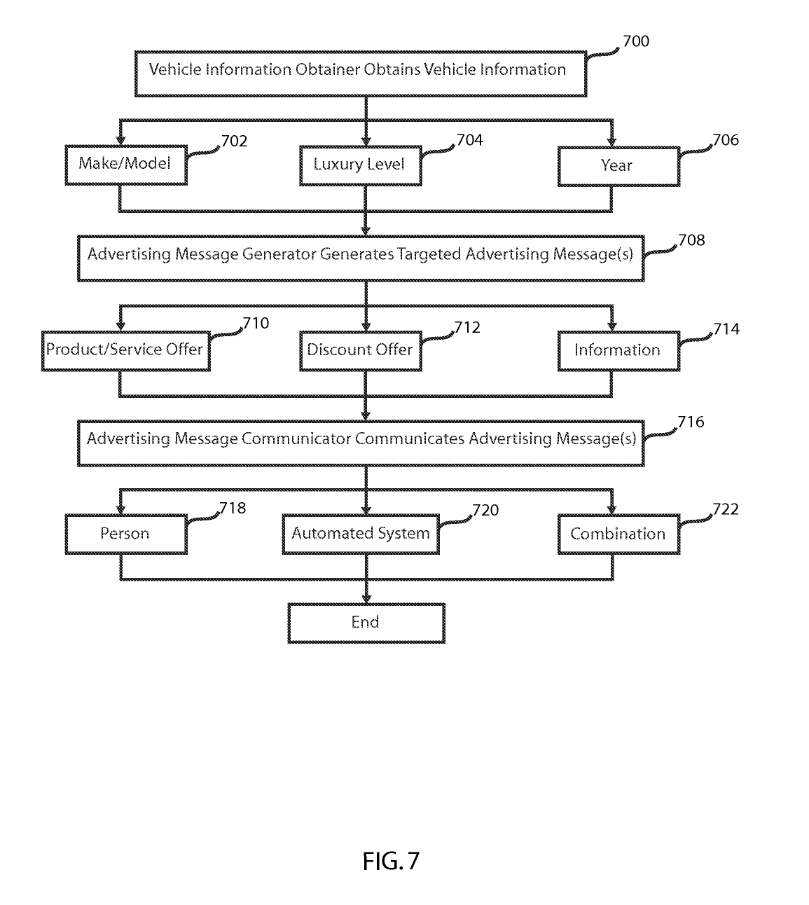

FIG. 7 is a flow chart detailing the steps involved in an implementation of an embodiment of the advertising system. First, a vehicle information obtainer obtains vehicle information regarding a vehicle that is owned and/or operated by a potential customer 700. Such vehicle information can include make and/or model information 702, sub-model information indicating luxury level 704, and/or model year 706, as well as potentially other information such as information regarding the accessories included in the vehicle. Other information not related to the potential customer's vehicle can also be considered, such as the gender, age and/or place of residence and/or business of the potential customer, for example; or even information not related to the customer, such as the location where the advertising message is given, and/or the time of day, for example. One of ordinary skill in the art will recognize other potentially useful pieces of vehicle information relevant to generating an appropriate targeted advertising message.

Next, an advertising message generator generates a targeted advertising message or messages which are determined to be of interest to the potential customer 708. The advertising message or messages are deemed to be of potential interest to the potential customer by virtue of the vehicle information revealed about the vehicle owned and/or operated by the potential customer. Advertising messages of potential interest can include, but are not limited to, an offer of a product and/or service 710, an offer of a discount 712 and/or free trial of such product and/or service, and/or other information 714 relating thereto.

Next, an advertising message communicator communicates the advertising message or messages to the potential customer, based upon the vehicle information obtained 716. The advertising message can be communicated in a variety of ways, as indicated above in connection with previous figures. For example, a person can communicate an advertising message or messages 718 directly or via telephone, email or other medium; or alternatively, the advertising message can be communicated automatically 720, such as by a printer, a sound and/or video system, or other automated system. The advertising message can also be communicated via a combination of a person and an automated system 722. Other forms of communication will occur to one of ordinary skill in the art.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed is:

1. A system of providing an advertising message based on information regarding a potential customer's vehicle, the system comprising:
a vehicle information obtainer,
the vehicle information obtainer being capable of obtaining vehicle information regarding a vehicle at least one of owned and operated by a potential customer;
an advertising message generator,
the advertising message generator being capable of generating at least one targeted advertising message determined to be of interest to the potential customer, the advertising message generator using the vehicle information as a basis for a projection of a general purchasing mindset of the potential customer; and
an advertising message communicator,
the advertising message communicator being capable of communicating the at least one targeted advertising message to the potential customer.

2. The system of claim 1, wherein the vehicle information obtainer is at least one of:
a person capable of determining the vehicle information;
a machine vision system capable of determining the vehicle information;
a software program capable of soliciting the vehicle information directly from the potential customer;
a software program capable of obtaining the vehicle information from a source other than the potential customer;
a speech-recognition system capable of obtaining the vehicle information via speech recognition;
an email-based system capable of obtaining the vehicle information via an email; and
a telephony-based system capable of obtaining the vehicle information via a telephone call to the potential customer.

3. The system of claim 2, wherein the software program capable of obtaining the vehicle information directly from the potential customer is a web-based software program.

4. The system of claim 2, wherein the software program capable of obtaining the vehicle information from a source other than the potential customer is a web-based software program.

5. The system of claim 1, wherein the advertising message generator is one of:
a manual look-up table capable of relating the vehicle information to the at least one targeted advertising message; and
an automated look-up table capable of relating the vehicle information to the at least one targeted advertising message.

6. The system of claim 1, wherein the advertising message generator is at least one of:
a lookup of a pre-assembled advertising message; and
a real-time assembly of an advertising message.

7. The system of claim 1, wherein the advertising message communicator is at least one of:
a person capable of communicating the advertising message;
a printer capable of printing the advertising message;
a speech-synthesis system capable of providing a spoken advertising message;
an audio system capable of presenting an audio advertising message;
a video system capable of presenting a video advertising message;
an SMS text message generator capable of generating and sending a text message advertising message;
an email generator capable of generating and sending an email advertising message; and
a telephony-based system capable of delivering an advertising message via a telephone call.

8. The system of claim 1, wherein the information regarding a potential customer's vehicle includes at least one of:
make information, and
model information.

9. The system of claim 8, wherein model information includes sub-model information indicating luxury level.

10. The system of claim 1, wherein the information regarding a potential customer's vehicle includes:
accessories information.

11. The system of claim 1, wherein the information regarding a potential customer's vehicle includes:
model year.

12. The system of claim 1, wherein the advertising message is at least one of:
an offer of a product;
an offer of a service;
an offer of a discount on a product;
an offer of a discount on a service;
an offer of a free trial on a product;
an offer of a free trial on a service;
information about a launch of a product;
information about a launch of a service;
information relating to sale of a product;
information relating to sale of a service;
information relating to a product; and
information relating to a service.

13. The system of claim 1, wherein the advertising message is further informed by non-vehicle-related information pertaining to the potential customer.

14. The system of claim 13, wherein the non-vehicle information is the gender of the potential customer.

15. The system of claim 13, wherein the non-vehicle-related information is the age of the potential customer.

16. The system of claim 13, wherein the non-vehicle information is the location of residence of the potential customer.

17. The system of claim 13, wherein the non-vehicle information is the location of place of business of the potential customer.

18. The system of claim 1, wherein the advertising message is further informed by non-potential-customer-related information.

19. The system of claim 18, wherein the non-potential-customer-related is the location where the advertising message is given.

20. The system of claim 18, wherein the non-potential-customer-related information is the time of day.
